(19) United States
(12) Patent Application Publication
(10) Pub. No.: US 2011/0175878 A1
(43) Pub. Date: Jul. 21, 2011

(54) DRIVING METHOD FOR DISPLAY PANEL AND DISPLAY APPARATUS

(75) Inventors: Chung-Chih Hsiao, Taoyuan County (TW); Chiao-Lin Huang, Taoyuan County (TW); Shu-Yang Lin, Yunlin County (TW)

(73) Assignee: CHUNGHWA PICTURE TUBES, LTD., Taoyuan (TW)

(21) Appl. No.: 12/788,282

(22) Filed: May 26, 2010

(30) Foreign Application Priority Data
Jan. 18, 2010 (TW) 99101231

(51) Int. Cl. G09G 5/00

(52) U.S. Cl. 345/211

(57) ABSTRACT

A driving method for a display panel is provided. The driving method includes detecting whether the display panel switches between frames; and down-regulating/up-regulating the frame rate of the display panel and adjusting the voltage value of a gate-on power source when the display panel switches from a dynamic frame to a static frame or switches from the static frame to the dynamic frame, so as to change a charging current of pixels in the display panel.

### CROSS-REFERENCE TO RELATED APPLICATION

This application claims the priority benefit of Taiwan application serial no. 99101231, filed on Jan. 18, 2010. The entirety of the above-mentioned patent application is hereby incorporated by reference herein and made a part of specification.

### BACKGROUND OF THE INVENTION

1. Field of the Invention

The present invention is related to a display panel driving method and a display device using the same, and more particularly, to a display panel driving method capable of improving the frame flickering on the display panel and a display device using the same.

2. Description of Related Art

Due to rapidly advancing semiconductor technologies in the recent years, portable electronics and flat panel displays have also gained popularity. Among various types of FDP, liquid crystal displays (LCDs) have gradually become the mainstream display products due to the advantages such as a low operating voltage, free of harmful radiation, light weight and small and compact size.

Taking the portable electronic product such as the notebook (NB) equipped with the liquid crystal display as an example, in order to effectively decrease the battery power consumed by the liquid crystal display, Intel Corporation provides a seamless-dynamic-refresh-rate switching (SDRRS) technique to switch the frame rate of the display panel from 60 Hz for displaying the dynamic frame to 40 Hz while the liquid crystal display of the notebook displays the static frame. Hence, the battery power consumed by the liquid crystal display of the notebook can be effectively decreased so as to achieve the power saving purpose.

Since the resolution of the current display panel is getting higher, the pixels of the display panel cannot be charged to reach the corresponding target voltage while the frame rate is 60 Hz. However, most of the pixels of the display panel can be charged to reach the corresponding target voltage while the frame rate is 40 Hz. Thus, without implementing any over driving technique, when the notebook activates the SDRRS technique to switch the frame rate of the display panel from 60 Hz to 40 Hz (i.e. switching from the dynamic frame to the static frame), or from 40 Hz to 60 Hz (i.e. switching from the static frame to the dynamic frame), the amount of the stored charges (Q₆₀) of the pixels under the frame rate of 60 Hz is different from the amount of the stored charges (Q₄₀) of the pixels under the frame rate of 40 Hz because the charging time (T₆₀= 1/60) for the pixels at the frame rate of 60 Hz is different from the charging time (T₄₀= 1/40) for the pixels at the frame rate of 40 Hz. Hence, when the notebook activates the SDRRS technique, the brightness variation is obvious while the frame rates are switched from one to another. Thus, the viewer would likely perceive that the images are flickering.

For instance, when the user does not perform any operations on the notebook for a while (e.g. the user is reading an article), the notebook activates the SDRRS technique to switch the frame rate of the display panel from 60 Hz to 40 Hz (i.e. switching from the dynamic frame to the static frame). During the switching process, the brightness varies due to the switching of the frame rate so that the user is likely to perceive the brightness of the images is switched from dark to bright (i.e. the frame flickering). Moreover, when the user performs operations on the notebook through the mouse or the keyboard at next time, the notebook activates the SDRRS technique to switch the frame rate of the display panel from 40 Hz to 60 Hz (i.e. switching from the static frame to the dynamic frame). During the aforementioned switching process, the brightness varies due to the switching of the frame rate so that the user is likely to perceive the brightness of the images is switched from bright to dark (i.e. the frame flickering).

### SUMMARY OF THE INVENTION

Accordingly, the present invention is directed to a driving method for a display panel capable of keeping the pixels of the display panel at the amount of same stored charges under the circumstance that the charging times determined by different frame rates are different from each other and when the notebook activates the SDRRS technique. Thus, the problem of the frame flickering due to brightness variation can be overcome.

The present invention provides a driving method of a display panel. The driving method includes detecting whether the display panel is switched from a dynamic frame to a static frame, and down-regulating a frame rate of the display panel and adjusting a voltage of a gate-on power source so as to change a charging current of pixels of the display panel when the display panel is switched from the dynamic frame to the static frame.

In one embodiment of the present invention, when the frame rate of the display panel is down-regulated, the voltage of the gate-on power source and the charging current of the pixels of the display panel may be decreased.

The present invention further provides a driving method of a display panel. The driving method includes detecting whether the display panel is switched from a static frame to a dynamic frame, and up-regulating a frame rate of the display panel and adjusting a voltage of a gate-on power source so as to change a charging current of pixels of the display panel when the display panel is switched from the static frame to the dynamic frame.

In one embodiment of the present invention, when the frame rate of the display panel is up-regulated, the voltage of the gate-on power source and the charging current of the pixels of the display panel may be increased.

In one embodiment of the present invention, when the display panel is not switched from the dynamic frame to the static frame or switched from the static frame to the dynamic frame, the frame rate of the display panel, the voltage of the gate-on power source and the charging current of the pixels of the display panel are remained unchanged.

In one embodiment of the present invention, the pixels of the display panel charged by the decreased or increased charging current obtain a first amount of charges equal to a second amount of charges obtained by charging the pixels of the display panel with the unchanged charging current.

The present invention further provides a display device including a display panel, a timing controller, a gate-on power source switching unit and a gate driver. The display panel has a plurality of pixels arranged in an array and is used for displaying a dynamic frame or a static frame. The timing controller is used for detecting whether the display panel switches between frames so as to regulate a frame rate of the display panel and output a gate-on power source switching signal. The gate-on power source switching unit is coupled to the timing controller, and used for receiving two gate-on power sources with different voltage values from each other and outputting one of the two gate-on power sources according to the gate-on power source switching signal. The gate driver is coupled to the display panel, the timing controller and the gate-on power source switching unit. The gate driver is controlled by the timing controller and used for sequentially outputting a scan signal to turn on each pixel row of the display panel one by one according to the output of the gate-on power source switching unit.

In one embodiment of the present invention, the timing controller down-regulates the frame rate of the display panel and outputs the gate-on power source switching signal with a first state when the timing controller detects that the display panel is switched from the dynamic frame to the static frame. In this case, the gate-on power source switching unit outputs a first gate-on power source with a relatively lower voltage value between the two gate-on power sources according to the gate-on power source switching signal with the first state. Also, the gate driver further sequentially outputs the scan signal having the voltage value of the first gate-on power source so as to turn on each pixel row of the display panel one by one.

In one embodiment of the present invention, the timing controller up-regulates the frame rate of the display panel and outputs the gate-on power source switching signal with a second state when the timing controller detects that the display panel is switched from the static frame to the dynamic frame. In this case, the gate-on power source switching unit outputs a second gate-on power source with a relatively higher voltage value between the two gate-on power sources according to the gate-on power source switching signal with the second state. Also, the gate driver further sequentially outputs the scan signal having the voltage value of the second gate-on power source as to turn on each pixel row of the display panel one by one.

From the above, the driving method of the display panel submitted by the present invention utilizes the timing controller to detect whether the display panel is switched between the dynamic frame and the static frame so as to output the gate-on power source switching signal with different states to switch the gate-on power source to a proper voltage. Hence, when the notebook activates the SDRRS technique, the pixels under different charging times determined by different frame rates (e.g. 60 Hz and 40 Hz) possess the same amount of stored charges (i.e. Q₆₀=Q₄₀). Thus, the problem of frame flickering due to the brightness variation can be overcome.

In order to make the aforementioned features and advantages of the invention comprehensible, several embodiments accompanied with figures are described in detail below. The above general descriptions and following exemplary embodiments are only for explanation and presented as examples, but not intended to limit the scope of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing a system of a display device according to one embodiment of the present invention.

FIG. 2 is a circuit diagram of a gate-on power source switching unit according to one embodiment of the present invention.

FIG. 3 is flow chart showing a driving method of a display panel according to one embodiment of the present invention.

### DESCRIPTION OF EMBODIMENTS

It is to be understood that both the foregoing and other detailed descriptions, features, and advantages are intended to be described more comprehensively by providing embodiments accompanied with figures hereinafter. Reference will now be made in detail to the exemplary embodiments of the invention, examples of which are illustrated in the accompanying drawings. In addition, whenever possible, identical or similar reference numbers stand for identical or similar elements in the figures and the embodiments.

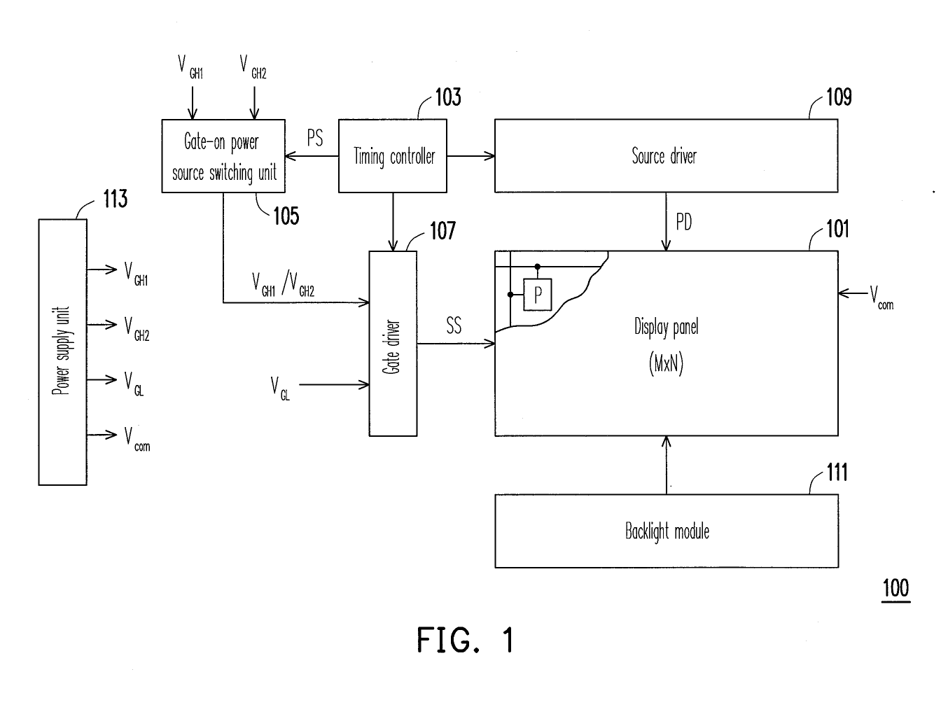

FIG. 1 is a block diagram showing a system of a display device 100 according to one embodiment of the invention. As shown in FIG. 1, the display device 100 can be, for example, a liquid crystal display and can be applied into the notebook (NB), but not limited thereto. The display device 100 includes a display panel 101, a timing controller (T-con) 103, a gate-on power source switching unit 105, a gate driver 107, a source driver 109, a backlight module 111 and a power supply unit 113.

In the present embodiment, the display panel 101 has a plurality of pixels P arranged in an M×N array. Further, the display panel 101 is driven by the gate driver 107 and the source driver 109 so as to accompany with the light source (plane light source) provided by the backlight module 111 to display an image, for example, a dynamic frame or a static frame.

The timing controller 103 is used to detect whether the display panel 101 is switched from the dynamic frame to the static frame or from the static frame to the dynamic frame. In the present embodiment, the timing controller 103 detecting whether the display panel 101 is switched between the dynamic frame and the static frame depends on determining whether the notebook activates the seamless dynamic refresh rate switching (SDRRS) technique.

When the timing controller 103 detects that the display panel 101 is switched from the dynamic frame to the static frame, the timing controller 103 down-regulates the frame rate of the display panel 101 (e.g. the frame rate is down-regulated from 60 Hz to 40 Hz), and outputs a gate-on power source switching signal PS with a first state (e.g. the logic low level). Alternatively, when the timing controller 103 detects that the display panel 101 is not switched from the dynamic frame to the static frame, the timing controller 103 keeps the frame rate of the display panel 101 as a first frame rate (i.e. 60 Hz), and outputs the gate-on power source switching signal PS with a second state (e.g. the logic high level).

Furthermore, when the timing controller 103 detects that the display panel 101 is switched from the static frame to the dynamic frame, the timing controller 103 up-regulates the frame rate of the display panel 101 (e.g. the frame rate is up-regulated from 40 Hz to 60 Hz), and outputs the gate-on power source switching signal PS with the second state (e.g. the logic high level). Alternatively, when the timing controller 103 detects that the display panel 101 is not switched from the static frame to the dynamic frame, the timing controller 103 keeps the frame rate of the display panel 101 as a second frame rate (i.e. 40 Hz), and outputs the gate-on power source switching signal PS with the first state (e.g. the logic low level).

The gate-on power source switching unit 105 is coupled to the timing controller 103. Further, the gate-on power source switching unit 105 is used for receiving two gate-on power sources V_{GH1} (e.g. 20V, but not limited thereto) and V_{GH2} (e.g. 24V, but not limited thereto) with different voltages. Further, according to the gate-on power source switching signal PS with the logic low level, the gate-on power source switching unit 105 outputs the first gate-on power source V_{GH1} with the voltage smaller than that of the second gate-on power source V_{GH2}. Moreover, according to the gate-on power source switching signal PS with the logic high level, the gate-on power source switching unit 105 further outputs the second gate-on power source V_{GH2} with voltage larger than that of the first gate-on power source V_{GH1}.

The gate driver 107 is coupled to the display panel 101, the timing controller 103 and the gate-on power source switching unit 105. The gate driver 107 is controlled by the timing controller 103 (i.e. the timing controller controls the operation of the gate driver 107) to sequentially output a scan signal SS having the voltage (i.e. 20V) of the first gate-on power source V_{GH1} or to sequentially output a scan signal SS having the voltage (i.e. 24V) of the second gate-on power source V_{GH2}, so as to turn on each pixel row of the display panel 101 one by one. Furthermore, the gate driver 107, according to the received gate-off power source V_{GL} to turn off the pixels P in the display panel 101.

In the present embodiment, when the gate-on power source switching unit 105 outputs the first gate-on power source V_{GH1}, the timing controller 103 controls the gate driver 107 to sequentially output the scan signal SS having the voltage of the first gate-on power source V_{GH1} so as to turn on each pixel row of the display panel 101 one by one. Also, when the gate-on power source switching unit 105 outputs the second gate-on power source V_{GH2}, the timing controller 103 controls the gate driver 107 to sequentially output the scan signal SS having the voltage of the second gate-on power source V_{GH2} so as to turn on each pixel row of the display panel 101 one by one.

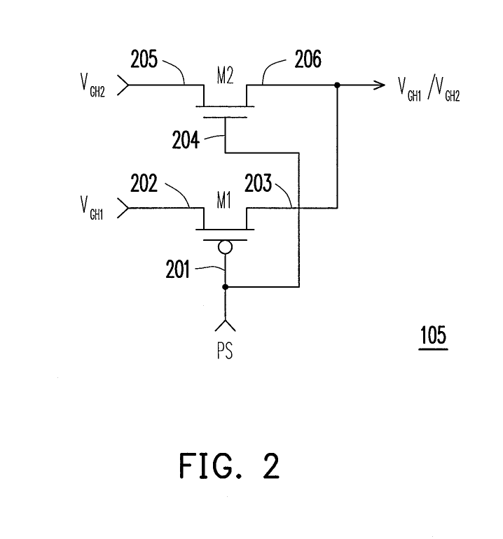

FIG. 2 is a circuit diagram of a gate-on power source switching unit 105 according to one embodiment of the present invention. As shown in FIG. 1 together with FIG. 2, the gate-on power source switching unit 105 includes a first type of transistor (herein, a P-type transistor is used as an exemplar and the present invention is not limited by the type of the transistor used herein) M1 and a second type of transistor (herein, an N-type transistor is used as an exemplar and the present invention is not limited by the type of the transistor used herein) M2. The gate 201 of the P-type transistor M1 is used to receive the gate-on power source switching signal PS with the logic low level or the logic high level. The first drain/source 202 of the P-type transistor M1 is used to receive the first gate-on power source V_{GH1}, and the second drain/source 203 of the P-type transistor M1 is used to output the first gate-on power source V_{GH1}. Also, the gate 204 of the N-type transistor M2 is used to receive the gate-on power source switching signal PS with the logic low level or the logic high level. The first drain/source 205 of the N-type transistor M2 is used to receive the second gate-on power source V_{GH2}, and the second drain/source 206 of the N-type transistor M2 is used to output the second gate-on power source V_{GH2}.

Accordingly, when the timing controller 103 outputs the gate-on power source switching signal PS with the logic low level, the P-type transistor M1 is turned on and the N-type transistor M2 is turned off. Thus, the gate-on power source switching unit 105 outputs the first gate-on power source V_{GH1}. In another aspect, when the timing controller 103 outputs the gate-on power source switching signal PS with the logic high level, the P-type transistor M1 is turned off and the N-type transistor M2 is turned on. Thus, the gate-on power source switching unit 105 outputs the second gate-on power source V_{GH2}.

Herein, as shown in FIG. 1, the source driver 109 is coupled to the display panel 101 and the timing controller 103. The source driver 109 is controlled by the timing controller 103 (i.e. the timing controller 103 controls the operation of the source driver 109) to correspondingly provide the pixel data PD to the pixels turned on by the gate driver in each pixel row the display panel 101. The backlight module 111 is used to provide a light source (plane light source) for the display panel 101, and the backlight module 111 can be a direct type backlight module or a side incident type backlight module. The light source of any type of the backlight module can be composed of a plurality of cold cathode fluorescent lamps (CCFL) parallel to one another or a plurality of light emitting diodes (LED) arranged in an array.

The power supply unit 113 is coupled to the display panel 101, the gate-on power source switching unit 105 and the gate driver 107. The power supply unit 113 is used to provide a common voltage V_{com}, to each of the pixels P in the display panel 101, and to provide the first gate-on power source V_{GH1} and the second gate-on power source V_{GH2} to the gate-on power source switching unit 105, and to provide the gate-off power source V_{GL} to the gate driver 107. It should be noticed that, in the present embodiment, any system power source for the display device 100 should be generated and provided through the power supply unit 113.

In the present embodiment, if the notebook (NB) activates the SDRSS technique to switch the frame rate of the display panel 101 from 60 Hz to 40 Hz. That is, the display panel 101 is switched from the dynamic frame to the static frame. The timing controller 103 detecting whether the display panel 101 is switched between the dynamic frame and the static frame depends on determining whether the notebook activates the SDRSS technique. Hence, the timing controller 103 outputs the gate-on power source switching signal PS with the logic low level to the gate-on power source switching unit 105 so that the gate-on power source switching unit 105 outputs the first gate-on power source V_{GH1} to the gate driver 107.

Then, the timing controller 103 controls the gate driver 107 to sequentially output the scan signal SS having the voltage of the first gate-on power source V_{GH1} so as to turn on each pixel row of the display panel 101 one by one, and let the pixels, which are turned on by the gate driver 107, in each pixel row of the display panel 101 receive the pixel data PD correspondingly provided by the source driver 109. In the present embodiment, the amount of the stored charges (Q₆₀) of the pixels P under the circumstance that the frame rate of the display panel 101 is about 60 Hz is assumed to be I₆₀*T₆₀ (Q₆₀=I₆₀*T₆₀), wherein I₆₀ is the charging current of the pixels P and T₆₀ is the charging time of the pixels P while the frame rate of the display panel is 60 Hz, and the charging current I₆₀ is determined according to the following equation (1):

$${I}_{60} = \frac{1}{2} {K ( {V}_{gh ( 60 )} - {V}_{T} )}^{2} , \qquad equation ( 1 )$$

Wherein V_{gh(60)} indicates the gate-on power source of the pixels P as the frame rate of 60 Hz (i.e. the second gate-on power source V_{GH2}), K is a constant, and V_{T} indicates a threshold value of active devices (which usually are thin film transistors) of the pixels.

In the present embodiment, the amount of the stored charges (Q₄₀) of the pixels P under the circumstance that the frame rate of the display panel 101 is about 40 Hz is assumed to be I₄₀*T₄₀ (i.e. Q₄₀=I₄₀*T₄₀), wherein I₄₀ is the charging current of the pixels P and T₄₀ is the charging time of the pixels P while the frame rate of the display panel is 40 Hz, and the charging current I₄₀ is determined according to the following equation (2):

$${I}_{40} = \frac{1}{2} {K ( {V}_{gh ( 40 )} - {V}_{T} )}^{2} , \qquad equation ( 2 )$$

Wherein V_{gh(40)} indicates the gate-on power source of the pixels P as the frame rate of 40 Hz (i.e. the first gate-on power source V_{GH1}), K is a constant, and V_{T} indicates a threshold value of active devices (which usually are thin film transistors) of the pixels.

According to the aforementioned equation (1) and equation (2), when the amount of the stored charges Q₆₀ is equal to the amount of the stored charges Q₄₀ (i.e. Q₆₀=Q₄₀), there is no brightness variation of the image displayed under different frame rates when the notebook activates the SDRRS technique to switch the frame rate of the display panel 101 from 60 Hz to 40 Hz. Hence, under the conditions of I₆₀*T₆₀=I₄₀*T₄₀, while the frame rate of the display panel 101 is 40 Hz, only the gate-on power source V_{gh(40)} (i.e. the first gate-on power source V_{GH1}) of the pixels P needs to be adjusted to the voltage according to the following equation (3) so that no brightness variation of the image while the display panel 101 is switched between two frames (i.e. the dynamic frame and the static frame) can be achieved:

$${V}_{gh ( 40 )} = \sqrt{{( {V}_{gh ( 60 )} - {V}_{T} )}^{2} \frac{{T}_{60}}{{T}_{40}}} + {V}_{T} , \qquad equation ( 3 )$$

In other words, when the notebook activates the SDRRS technique to switch the frame rate of the display panel 101 from 60 Hz to 40 Hz (i.e. the display panel 101 is switched from the dynamic frame to the static frame), only the gate-on power source V_{gh(40)} (i.e. the first gate-on power source V_{GH1}) as the frame rate of 40 Hz is down-regulated (e.g. the second gate-on power source V_{GH2} of about 24V is down-regulated to the first gate-on power source V_{GH1} of about 20V and is not limited thereto). Thus, the charging current (I₄₀) of the pixels P as the frame rate of 40 Hz is accordingly decreased. Hence, the amount of the stored charges (Q₄₀) of the pixels P as the frame rate of 40 Hz is equal to the amount of the stored charges (Q₆₀) of the pixels P as the frame rate of 60 Hz. Accordingly, there is no brightness variation of the image while the display panel is switched between two different frames (i.e. the dynamic frame and the static frame).

Similarly, when the notebook activates the SDRRS technique to switch the frame rate of the display panel 101 from 40 Hz to 60 Hz (i.e. the display panel 101 is switched from the static frame to the dynamic frame), only the gate-on power source V_{gh(60)} (i.e. the second gate-on power source V_{GH2}) as the frame rate of 60 Hz is up-regulated (e.g. the first gate-on power source V_{GH1} of about 20V is up-regulated to the second gate-on power source V_{GH2} of about 24V and is not limited thereto). Thus, the charging current (I₆₀) of the pixels P as the frame rate of 60 Hz is accordingly increased. Hence, the amount of the stored charges (Q₆₀) of the pixels P as the frame rate of 60 Hz is equal to the amount of the stored charges (Q₄₀) of the pixels P as the frame rate of 40 Hz. Accordingly, there is no brightness variation of the image while the display panel is switched between two different frames (i.e. the dynamic frame and the static frame).

Moreover, when the notebook does not activate the SDRRS technique, the timing controller 103 keeps the frame rate of the display panel (i.e. the frame rate of 40 Hz or 60 Hz), the voltage of the gate-on power source (i.e. V_{GH1} or V_{GH2}) and the charging current of pixels P of the display panel 101 unchanged. In other words, the pixels P of the display panel 101 charged by the decreased or increased charging current obtain a first amount of charges which is equal to a second amount of charges obtained by charging the pixels P of the display panel 101 with the unchanged charging current. Altogether, the amount of the stored charges (Q₆₀) of the pixels P as the frame rate of 60 Hz is equal to the amount of the stored charges (Q₄₀) of the pixels P as the frame rate of 40 Hz, and vice versa.

Noticeably, since the resolution of the current display panel is getting higher, the pixels of the display panel cannot be charged to reach the corresponding target voltage while the frame rate is 60 Hz. However, most of the pixels of the display panel can be charged to reach the corresponding target voltage while the frame rate is 40 Hz. Accordingly, in the present embodiment, without implementing any over driving technique, when the notebook activates the SDRRS technique to switch the frame rate of the display panel from 60 Hz to 40 Hz (i.e. switching from the dynamic frame to the static frame), or from 40 Hz to 60 Hz (i.e. switching from the static frame to the dynamic frame), the voltage of the scan signal for turning on the pixels are down-regulated so that the pixels also cannot be charged to reach the corresponding target voltage even the frame rate is 40 Hz. Hence, the amounts of the stored charges of the pixels under different frames are equal to each other. Accordingly, there is no brightness variation while the display panel is switched between the frames and the problem of the frame flickering can be overcome.

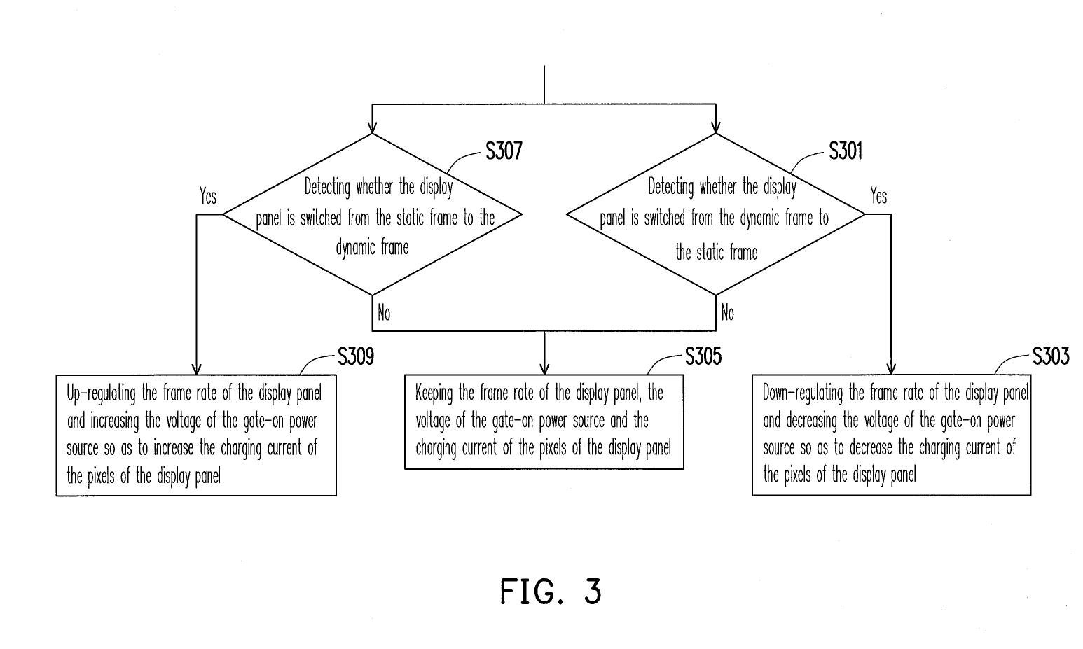

By summarizing the contents of the embodiments mentioned above, FIG. 3 is flow chart showing a driving method of a display panel according to one embodiment of the present invention. As shown in FIG. 3, the driving method of the display panel of the present embodiment includes detecting whether the display panel is switched from the dynamic frame to the static frame (step S301) or from the static frame to the dynamic frame (step S307). In the present embodiment, when it is detected that the display panel is switched from the dynamic frame to the static frame in the step S301, the frame rate of the display panel is down-regulated and the voltage of the gate-on power source is decreased so as to decrease the charging current of the pixels of the display panel (step S303). Alternatively, when it is detected that the display panel is not switched from the dynamic frame to the static frame in the step S301, the frame rate of the display panel, the voltage of the gate-on power source and the charging current of the pixels of the display panel are remained unchanged (step S305). Thus, the pixels of the display panel charged by the decreased charging current obtain the first amount of charges which is equal to the second amount of charges obtained by charging the pixels of the display panel with the unchanged charging current.

In the present embodiment, when it is detected that the display panel is switched from the static frame to the dynamic frame in the step S307, the frame rate of the display panel is up-regulated and the voltage of the gate-on power source is increased so as to increase the charging current of the pixels of the display panel (step S309). Alternatively, when it is detected that the display panel is not switched from the static frame to the dynamic frame in the step S307, the frame rate of the display panel, the voltage of the gate-on power source and the charging current of the pixels of the display panel are remained unchanged (step S305). Thus, the pixels of the display panel charged by the increased charging current obtain the first amount of charges which is equal to the second amount of charges obtained by charging the pixels of the display panel with the unchanged charging current.

In light of the foregoing description, the driving method of the display panel of the present invention utilizes the timing controller to detect whether the display panel is switched between the dynamic frame and the static frame so as to output the gate-on power source switching signal with different states (e.g. the logic high level or the logic low level) to switch the gate-on power source (e.g. V_{GH1} or V_{GH2}) to a proper voltage. Hence, when the notebook activates the SDRRS technique, the pixels under different charging times (e.g. T₆₀ and T₄₀) determined by different frame rates (e.g. 60 Hz and 40 Hz) possess the same amount of stored charges (i.e. Q₆₀=Q₄₀). Thus, the problem of frame flickering due to the brightness variation can be overcome.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving method of a display panel, comprising:
detecting whether the display panel is switched from a dynamic frame to a static frame; and
when the display panel is switched from the dynamic frame to the static frame, down-regulating a frame rate of the display panel and adjusting a voltage of a gate-on power source so as to change a charging current of pixels of the display panel.

2. The driving method of claim 1, wherein when the frame rate of the display panel is down-regulated, the step of adjusting the voltage of the gate-on power source comprises:
decreasing the voltage of the gate-on power source.

3. The driving method of claim 2, wherein when the voltage of the gate-on power source is decreased, the step of changing the charging current of the pixels of the display panel comprises:
decreasing the charging current of the pixels of the display panel.

4. The driving method of claim 3, further comprising:
when the display panel is not switched from the dynamic frame to the static frame, keeping the frame rate of the display panel, the voltage of the gate-on power source and the charging current of the pixels of the display panel unchanged.

5. The driving method of claim 4, wherein the pixels of the display panel charged by the decreased charging current obtain a first amount of charges equal to a second amount of charges obtained by charging the pixels of the display panel with the unchanged charging current.

6. A driving method of a display panel, comprising:
detecting whether the display panel is switched from a static frame to a dynamic frame; and
when the display panel is switched from the static frame to the dynamic frame, up-regulating the frame rate of the display panel and adjusting a voltage of a gate-on power source so as to change a charging current of pixels of the display panel.

7. The driving method of claim 6, wherein when the frame rate of the display panel is up-regulated, the step of adjusting the voltage of the gate-on power source comprises:
increasing the voltage of the gate-on power source.

8. The driving method of claim 7, wherein when the voltage of the gate-on power source is increased, the step of changing the charging current of the pixels of the display panel comprises:
increasing the charging current of the pixels of the display panel.

9. The driving method of claim 8, further comprising:
when the display panel is not switched from the static frame to the dynamic frame, keeping the frame rate of the display panel, the voltage of the gate-on power source and the charging current of the pixels of the display panel unchanged.

10. The driving method of claim 9, wherein the pixels of the display panel charged by the increased charging current obtain a first amount of charges equal to a second amount of charges obtained by charging the pixels of the display panel with the unchanged charging current.

11. A display device, comprising:
a display panel having a plurality of pixels arranged in an array, for displaying a dynamic frame or a static frame;
a timing controller for detecting whether the display panel switches between frames so as to regulate a frame rate of the display panel accordingly and to output a gate-on power source switching signal;
a gate-on power source switching unit coupled to the timing controller for receiving two gate-on power sources with different voltages and for outputting one of the two gate-on power sources according to the gate-on power source switching signal; and
a gate driver coupled to the display panel, the timing controller and the gate-on power source switching unit, wherein the gate driver is controlled by the timing controller and used for sequentially outputting a scan signal to turn on each pixel row of the display panel one by one according to the output of the gate-on power source switching unit.

12. The display device of claim 11, wherein the timing controller down-regulates the frame rate of the display panel and outputs the gate-on power source switching signal with a first state when the timing controller detects that the display panel is switched from the dynamic frame to the static frame.

13. The display device of claim 12, wherein the gate-on power source switching unit outputs a first gate-on power source with a relatively lower voltage between the two gate-on power sources according the gate-on power source switching signal with the first state.

14. The display device of claim 13, wherein the gate driver sequentially outputs the scan signal having a voltage of the first gate-on power source so as to turn on each pixel row of the display panel one by one.

15. The display device of claim 13, wherein the timing controller up-regulates the frame rate of the display panel and outputs the gate-on power source switching signal with a second state when the timing controller detects that the display panel is switched from the static frame to the dynamic frame.

16. The display device of claim 15, wherein the gate-on power source switching unit outputs a second gate-on power source with a relatively higher voltage between the two gate-on power sources according the gate-on power source switching signal with the second state.

17. The display device of claim 16, wherein the gate driver sequentially outputs the scan signal having a voltage of the second gate-on power source so as to turn on each pixel row of the display panel one by one.

18. The display device of claim 16, wherein the timing control keeps the frame rate of the display panel to be a first frame rate and outputs the gate-on power source switching signal with the second state when the timing controller detects that the display panel is not switched from the dynamic frame to the static frame.

19. The display device of claim 18, wherein the timing control keeps the frame rate of the display panel to be a second frame rate and outputs the gate-on power source switching signal with the first state when the timing controller detects that the display panel is not switched from the static frame to the dynamic frame.

20. The display device of claim 19, wherein the first frame rate is higher than the second frame rate.

21. The display device of claim 16, wherein the gate-on power source switching unit comprises:
a first transistor having a gate receiving the gate-on power source switching signal with the first state or the second state, a first drain/source receiving the first gate-on power source, and a second drain/source outputting the first gate-on power source; and
a second transistor having a gate receiving the gate-on power source switching signal with the first state or the second state, a first drain/source receiving the second gate-on power source, and a second drain/source outputting the second gate-on power source.

22. The display device of claim 21, wherein the first transistor is a P-type transistor and the second transistor is an N-type transistor.

23. The display device of claim 16, further comprising:
a source driver coupled to the display panel and the timing controller, wherein the source driver is controlled by the timing controller and used for correspondingly providing a pixel data to the pixels, which are turned on by the gate driver, in each pixel row of the display panel;
a backlight module for providing a backlight source required by the display panel; and
a power supply unit coupled to the gate-on power source switching unit, the gate driver and the display panel, wherein the power supply unit provides the first and the second gate-on power sources to the gate-on power source switching unit, provides a gate-off power source to the gate driver and provides a common voltage to the display panel.
